(19) United States
(12) Patent Application Publication
(10) Pub. No.: US 2025/0041914 A1
(43) Pub. Date: Feb. 6, 2025

(54) CLEANING APPLIANCE

(71) Applicant: Alfred Kärcher SE & Co. KG, Winnenden (DE)

(72) Inventors: Rick PETZOLD, Winnenden (DE); Andreas KRAUTER, Winnenden (DE)

(21) Appl. No.: 18/918,999

(22) Filed: Oct. 17, 2024

Related U.S. Application Data
(63) Continuation of application No. PCT/EP2023/059992, filed on Apr. 18, 2023.

(30) Foreign Application Priority Data
Apr. 20, 2022 (DE) 10 2022 109 526.6

(51) Int. Cl. B08B 7/00; B08B 5/02; B24C 1/00; C01B 32/55; F28D 7/02

(52) U.S. Cl. CPC B08B 7/0092; B08B 5/02; C01B 32/55; B24C 1/003; F28D 7/024

(57) ABSTRACT

A cleaning appliance for blasting surfaces to be treated with a mixed stream of a pressurized gas and CO₂ pellets is disclosed and includes an apparatus for producing CO₂ pellets from liquid or gaseous CO₂, wherein the apparatus includes a compressing device for compressing CO₂ snow to form the CO₂ pellets, wherein the compressing device includes an expansion device for creating CO₂ snow by expanding liquid or pressurized CO₂, wherein the expansion device includes an expansion chamber with an expansion chamber inlet, wherein the cleaning appliance includes a CO₂ connection line that is fluidically connected to the expansion chamber inlet for supplying the liquid or gaseous CO₂ to the expansion device, and wherein the cleaning appliance includes a cooling device for cooling the CO₂ connection line.

### CROSS-REFERENCE TO RELATED APPLICATIONS

This application is a continuation of international application number PCT/EP2023/059992, filed on Apr. 18, 2023, and claims the benefit of German application number 10 2022 109 526.6, filed on Apr. 20, 2022, which are incorporated herein by reference in their entirety and for all purposes.

### FIELD OF THE INVENTION

The present invention relates to cleaning appliances for blasting surfaces to be treated with a mixed stream of a pressurized gas and CO₂ pellets generally, and more specifically to a cleaning appliance for blasting surfaces to be treated with a mixed stream of a pressurized gas and CO₂ pellets, comprising an apparatus for producing CO₂ pellets from liquid or gaseous CO₂, wherein the apparatus comprises a compressing device for compressing CO₂ snow to form the CO₂ pellets, wherein the compressing device comprises an expansion device for creating CO₂ snow by expanding liquid or pressurized CO₂, wherein the expansion device comprises an expansion chamber with an expansion chamber inlet, and wherein the cleaning appliance comprises a CO₂ connection line that is fluidically connected to the expansion chamber inlet for supplying the liquid or gaseous CO₂ to the expansion device.

### BACKGROUND OF THE INVENTION

A cleaning appliance of the kind described at the outset is known, e.g., from WO 2015/079022 A1. With this cleaning appliance, it is possible to produce CO₂ pellets, i.e. so-called dry ice pellets, from liquid CO₂.

A problem with known cleaning appliances of that kind is, in particular, the limited yield of CO₂ pellets producible from a predetermined amount of liquid CO₂.

### SUMMARY OF THE INVENTION

In a first aspect of the invention a cleaning appliance for blasting surfaces to be treated with a mixed stream of a pressurized gas and CO₂ pellets, comprises an apparatus for producing CO₂ pellets from liquid or gaseous CO₂. The apparatus comprises a compressing device for compressing CO₂ snow to form the CO₂ pellets. The compressing device comprises an expansion device for creating CO₂ snow by expanding liquid or pressurized CO₂. The expansion device comprises an expansion chamber with an expansion chamber inlet. The cleaning appliance comprises a CO₂ connection line that is fluidically connected to the expansion chamber inlet for supplying the liquid or gaseous CO₂ to the expansion device. The cleaning appliance comprises a cooling device for cooling the CO₂ connection line.

### BRIEF DESCRIPTION OF THE DRAWING FIGURES

The foregoing summary and the following description may be better understood in conjunction with the drawing figures, of which:

FIG. 1 shows a schematic, partially broken total view of an embodiment of a cleaning appliance;

FIG. 2 shows a perspective, partially broken total view of the cleaning appliance from FIG. 1 without an outer housing;

FIG. 3 shows a further perspective view of the arrangement from FIG. 2;

FIG. 4 shows an enlarged, partially broken view of a cooling device of the cleaning appliance;

FIG. 5 shows a section view along line 5-5 in FIG. 4;

FIG. 6 shows a section view along line 6-6 in FIG. 5; and

FIG. 7 shows a schematic depiction of the structure of a further embodiment of a cleaning appliance.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a cleaning appliance for blasting surfaces to be treated with a mixed stream of a pressurized gas and CO₂ pellets, comprising an apparatus for producing CO₂ pellets from liquid or gaseous CO₂, wherein the apparatus comprises a compressing device for compressing CO₂ snow to form the CO₂ pellets, wherein the compressing device comprises an expansion device for creating CO₂ snow by expanding liquid or pressurized CO₂, wherein the expansion device comprises an expansion chamber with an expansion chamber inlet, and wherein the cleaning appliance comprises a CO₂ connection line that is fluidically connected to the expansion chamber inlet for supplying the liquid or gaseous CO₂ to the expansion device, wherein the cleaning appliance comprises a cooling device for cooling the CO₂ connection line.

The further development proposed in accordance with the invention makes it possible, in particular, to improve the efficiency of the cleaning appliance, i.e. in particular to increase the yield of CO₂ pellets from a predetermined amount of liquid CO₂. By means of the cooling device, the starting product of the cleaning appliance, i.e. pressurized gaseous or liquid CO₂, can be cooled. The colder the gaseous or liquid CO₂ is, the more efficiently it can be used in the subsequent process. Thus, more CO₂ snow can be produced, the colder the gaseous or liquid CO₂ used for this is. The cooling device may here be, in particular, an active cooling device, which cools the CO₂ connection line. For example, the cooling device can be powered by electricity.

To increase the efficiency of the cleaning appliance, provision may further be made that the cooling device is configured in the form of a passive cooling device. This has the advantage, in particular, that no additional energy has to be used to cool the CO₂ connection line. For example, the passive cooling device may be configured in the form of a counterflow cooling device. Thus, for example, a cool exhaust gas of the cleaning appliance, for example cool CO₂, can be used to cool the CO₂ connection line. In the counterflow cooling device, however, direct contact between the medium to be cooled, i.e. the liquid or gaseous CO₂ on the one hand, and the cooling medium on the other hand is prevented. Alternatively, any other sufficiently cool gas or liquid flow can be used as a cooling medium. The cooling device makes it possible, in particular, to pre-cool liquid CO₂ from bottles, which are not pre-conditioned, in order to thus create as much CO₂ snow as possible when expanding the liquid or gaseous CO₂.

The cleaning appliance can be formed in a simple manner if the cooling device comprises a heat exchanger and if the CO₂ connection line extends through the heat exchanger. This configuration makes it possible, in particular, to directly cool the CO₂ connection line, namely in the region in which it extends through the heat exchanger. It can then be cooled directly by a fluid flowing through the heat exchanger, i.e. a liquid or gas stream that has a correspondingly low temperature.

It is advantageous if the heat exchanger comprises a cooling channel with a cooling channel inlet and a cooling channel outlet and if the CO₂ connection line extends through the cooling channel. In particular, a connection line portion of the CO₂ connection line may extend through the cooling channel. Thus, in particular, it is not absolutely necessary that the entire CO₂ connection line is cooled, but rather it is sufficient if at least a connection line portion of the CO₂ connection line is cooled.

It is favorable if the heat exchanger has an inlet side and an outlet side and if the cooling channel inlet is arranged or formed on the inlet side and if the cooling channel outlet is arranged or formed on the outlet side. Thus, if the inlet side and the outlet side are spatially separated from one another, the cooling channel inlet and the cooling channel outlet can thus also be separated from one another in a simple manner. An optimal flow of a cooling fluid through the heat exchange can thus be achieved.

Preferably, the connection line portion extends from the outlet side through the cooling channel to the inlet side or vice versa. Such an arrangement makes it possible, in particular, to cool the liquid or gaseous CO₂ flowing through the CO₂ connection line by the counterflow method by means of a cooling fluid flowing through the cooling channel.

It is favorable if the connection line portion has a connection line portion length, if the cooling device has a cooling device length, which corresponds to a distance between the inlet side and the outlet side, and if a ratio between the connection line portion length and the cooling device length is in a range of about 5:1 to about 25:1. Such a configuration makes it possible, in particular, to select or predetermine a largest possible surface area of the heat exchanger that is optimized for heat exchange. The cooling device can still be formed compactly, however, in order to achieve a smallest possible size thereof, such that the cleaning appliance as a whole can maintain a moderate, manageable size.

For a simple handling of the cleaning appliance, it is advantageous if the cooling channel inlet and/or the cooling channel outlet comprise a hose connection piece for connecting to a hose in a fluid-tight manner. In particular, such a configuration makes it possible in a simple manner to conduct a cooling fluid through a hose to the cooling device and away therefrom after flowing through the cooling device.

It is favorable if the compressing device comprises a CO₂ exhaust gas outlet and if the CO₂ exhaust gas outlet is fluidically connected to the cooling channel inlet. This configuration makes it possible, in particular, to use the gaseous CO₂ exiting the pre-compression device, which has a significantly lower temperature than the ambient temperature of the cleaning appliance, as a cooling medium for cooling the CO₂ connection line, in particular the connection line portion thereof. Sublimated, i.e. gaseous, CO₂ that is created in the pre-compression device is then not only emitted to the environment of the cleaning appliance, but instead is first used to pre-cool the CO₂ connection line. The cooling device can thus be used, in particular, as a passive cooling device. No additional energy requirement is necessary to cool the CO₂ connection line. Rather, a waste product in the use of the cleaning appliance, namely cooled gaseous CO₂, is used as cooling fluid.

It is advantageous if the cleaning appliance comprises a CO₂ cleaning appliance exhaust gas outlet and if the cooling channel outlet is fluidically connected to the CO₂ cleaning appliance exhaust gas outlet. This configuration makes it possible, in particular, to discharge the gaseous CO₂ from or out of the cleaning appliance in a defined manner, for example to an environment thereof, after flowing through the cooling device. Optionally, the CO₂ cleaning appliance exhaust gas outlet may also be connected to a hose, for example in order to discharge the gaseous CO₂ created during the production process of CO₂ pellets from a cleaning space in which a surface to be treated is acted upon with a mixture of a pressurized gas and CO₂ pellets. A proportion of CO₂ in the ambient air of the cleaning appliance can thus be controlled in a defined manner.

Preferably, the cooling device comprises at least one heat conducting element, which is in thermal connection with the connection line portion. The at least one heat conducting element serves the purpose, in particular, of increasing a surface area of the connection line portion in order to thus achieve an improved heat exchange in the region of the cooling device.

The cooling device can be configured in a simple manner if the at least one heat conducting element is configured in the form of a heat conducting rib projecting from the connecting line portion and/or in the form of a woven fabric body, knitted fabric body, or wool body. Cooling medium, for example cold gaseous CO₂, can flow around heat conducting ribs or the described woven fabric body, knitted fabric body, or wool body, and cool them in this way. They are suited to remove heat from the connection line portion, so that the cooling fluid stream flowing through the cooling device is able to absorb this heat.

It is advantageous if the at least one heat conducting element is made of a heat conducting body material, which has a thermal conductivity of at least about 30 W/(m K). In particular, the thermal conductivity may be at least about 100 W/(m K). In particular, thermal conducting elements that are made of a metallic material are suitable for this purpose. Zinc, for example, has a thermal conductivity of about 110 W/(m K), aluminum about 230 W/(m K). Copper has a thermal conductivity in the range of about 240 to 380 W/(m K).

The cooling device can be configured in a simple and cost-effective manner if the at least one heat conducting element is made of a metallic material. Compared to plastic materials, metallic material, in particular pure metals or metal alloys such as, e.g., copper alloys or aluminum alloys, have a significantly higher thermal conductivity.

In order to increase a surface area of the CO₂ connection line, it is advantageous if the connection line portion is of helical configuration. In particular, it may be configured in the form of a helical coil. For this purpose, the connection line portion may be configured in form of a pipe that is helically wound.

In order to achieve a best possible heat transfer, it is favorable if the connection line portion is made of a metallic material. In particular when the connection line portion is in thermal contact with at least one heat conducting element, a cooling fluid flowing past the connection line portion can thus absorb heat from the connection line portion and can thus cool it.

A particularly compact structure of the cleaning appliance can be achieved, in particular, in that the heat exchanger comprises a heat exchanger housing and in that the heat exchanger housing defines the cooling channel. The flow of a cooling medium can thus be achieved in a simple manner, in particular by being conducted through the heat exchanger housing.

It is advantageous if the heat exchanger housing defines a heat exchanger housing longitudinal axis and is of cylindrical or substantially cylindrical or cuboidal or substantially cuboidal configuration. In this way, the cooling device can be configured in particular in a compact manner and a cooling of the CO₂ connection line can be optimized.

For a good cooling result, it is favorable if the cooling channel inlet and/or the cooling channel outlet is arranged or formed excentrically on the heat exchanger housing relative to the heat exchanger housing longitudinal axis. Thus, for example, the cooling channel inlet may be arranged on the inlet side of the heat exchanger excentrically or coaxially with the heat exchanger housing longitudinal axis. The CO₂ connection line on the inlet side may be conducted out of the heat exchanger housing coaxially with the heat exchanger housing longitudinal axis in the case of an excentrically arranged cooling channel inlet, or may also be conducted excentrically out of the heat exchanger housing relative to said heat exchanger housing longitudinal axis. In a corresponding manner, the cooling channel outlet may be arranged on the outlet side excentrically or coaxially with the heat exchanger housing longitudinal axis. Furthermore, in the case of an excentrically arranged cooling channel outlet, the CO₂ connection line may be conducted on the outlet side into the heat exchanger housing coaxially with the heat exchanger housing longitudinal axis or also excentrically relative to said heat exchanger housing longitudinal axis. In particular, an optimal cooling of the connection line portion of the CO₂ connection line in the heat exchanger housing according to the counterflow principle can be achieved in this way.

In accordance with a further preferred embodiment, provision may be made that the cooling channel inlet defines a cooling channel inlet longitudinal axis, that the cooling channel outlet defines a cooling channel outlet longitudinal axis, and that the cooling channel inlet longitudinal axis and/or the cooling channel outlet longitudinal axis extend in parallel to the heat exchanger housing longitudinal axis. This configuration makes it possible, in particular, to conduct the cooling fluid into the heat exchanger housing in a defined manner. In particular, a flow of the cooling fluid can thus be optimized so that a heat exchange preferably takes place in the heat exchanger housing and not before, i.e. outside of said heat exchanger housing.

Preferably, the cooling channel inlet longitudinal axis defines the cooling channel outlet longitudinal axis. The cooling channel inlet and the cooling channel outlet can thus be arranged or formed coaxially with one another on the heat exchanger. Thus, in particular, an optimized flow of the cooling fluid through the heat exchanger can be achieved.

It is advantageous if the heat exchanger housing defines a heat exchanger housing length and a heat exchanger housing diameter, and if a ratio between the heat exchanger housing length and the heat exchanger housing diameter is in a range of about 5:4 to about 5:1. In particular, the ratio may be in a range of about 3:2 to about 3:1. A heat exchanger of that kind is particularly compact in its design and can be retrofitted in a simple manner, for example to cleaning appliances that are already on the market.

It is favorable if the heat exchanger housing has a heat exchanger housing wall delimiting the cooling channel and if the heat exchanger housing wall is thermally insulated. It can thus be prevented, in particular, that the cooling medium excessively cools an environment of the heat exchanger. In other words, a cooling effect of the cooling fluid for the CO₂ connection line can thus be improved.

For a good thermal insulation of the cooling device, it is favorable if the heat exchanger housing wall is made of a heat exchanger housing wall material, which has a thermal conductivity of at most about 1 W/(m K). In particular, the thermal conductivity may be at most about 0.1 W/(m K). For example, the heat exchanger housing wall may be made of a plastic material, for example on a polyethylene or polystyrene basis. Polyurethane could also be considered as a heat exchanger housing wall material. The heat exchanger housing wall may optionally also comprise an insulating layer made of an insulation material suitable for this purpose, which preferably has a thermal conductivity that does not exceed the stated limit values. Possible suitable insulating materials are, in particular, mineral wool, sheep's wool, cellulose, flax, or wood fibers.

In accordance with a further preferred embodiment, provision may be made that the cleaning appliance comprises a CO₂ connection, which is connected or connectable to a CO₂ source, and that the CO₂ connection is fluidically connected to the CO₂ connection line. Such a cleaning appliance can be connected, for example, to a CO₂ bottle that contains liquid CO₂. The CO₂ can then be supplied via the CO₂ connection line to the expansion device.

It is advantageous if the expansion device comprises a switching device for opening and closing a fluidic connection between the CO₂ connection and the expansion chamber inlet and if the switching device is arranged or formed between the cooling device and the expansion chamber inlet. Such a configuration makes it possible, in particular, to operate the expansion device in a pulsed manner, such that liquid or gaseous CO₂ is only able to flow through the CO₂ connection line when the fluidic connection between the CO₂ connection and the expansion chamber inlet is open. The formation of CO₂ snow can thus be controlled in a simple manner with the switching device.

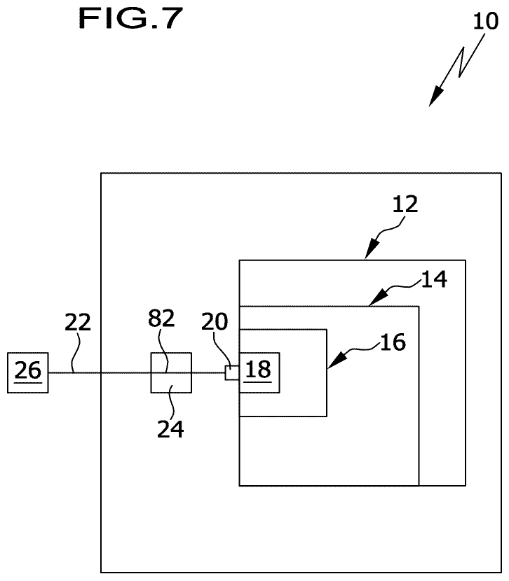

Schematically depicted in FIG. 7 is an embodiment of a cleaning appliance, denoted as a whole with the reference numeral 10, for blasting surfaces to be treated with a mixed stream of a pressurized gas, for example water-free or substantially water-free, i.e. dry pressurized air, and CO₂ pellets. The cleaning appliance 10 comprises an apparatus 12 for producing CO₂ pellets from liquid or gaseous CO₂.

The apparatus 12 comprises a compressing device 14 for compressing CO₂ snow to form the CO₂ pellets.

The compressing device 14 comprises an expansion device 16 for creating CO₂ snow by expanding liquid or pressurized CO₂. The expansion device 16 comprises an expansion chamber 18 with an expansion chamber inlet 20. Furthermore, the cleaning appliance 10 comprises a CO₂ connection line 22 that is fluidically connected to the expansion chamber inlet 20 for supplying the liquid or gaseous CO₂ to the expansion device 16.

For pre-cooling the liquid or gaseous CO₂, the cleaning appliance 10 comprises a cooling device 24 for cooling the CO₂ connection line 22. The CO₂ connection line 22 is connectable or connected to a CO₂ source 26. The CO₂ source may be, in particular, a CO₂ bottle 28 with liquid CO₂ or a CO₂ pressurized gas source.

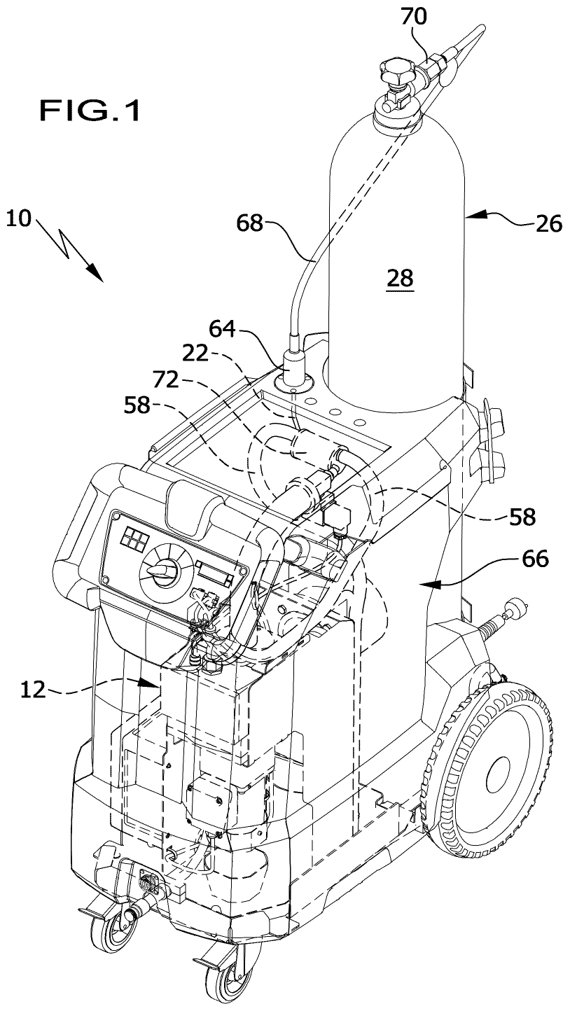

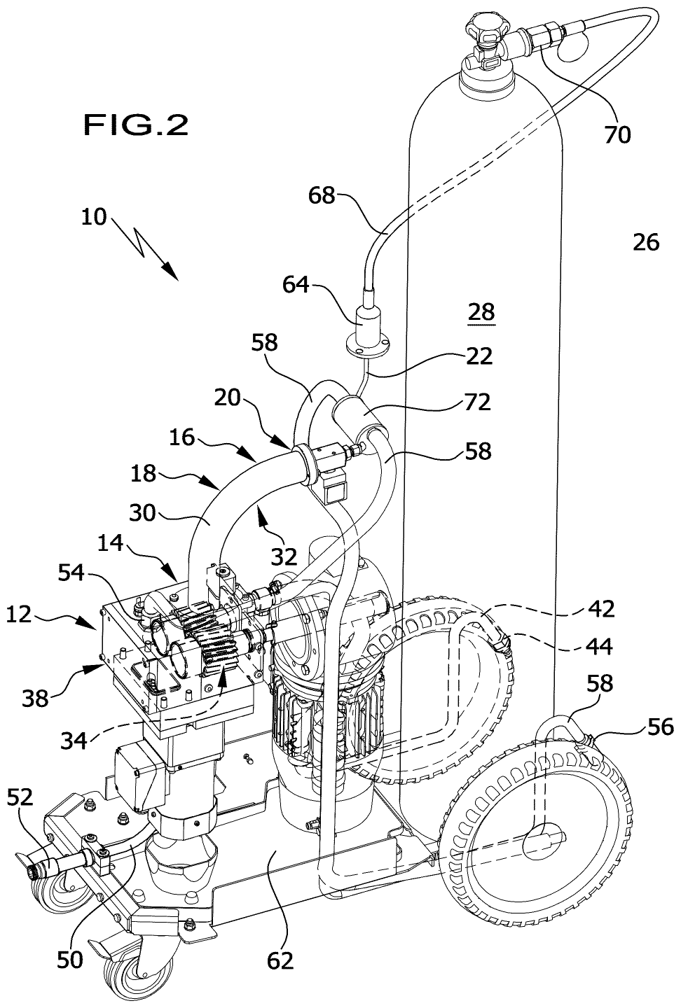

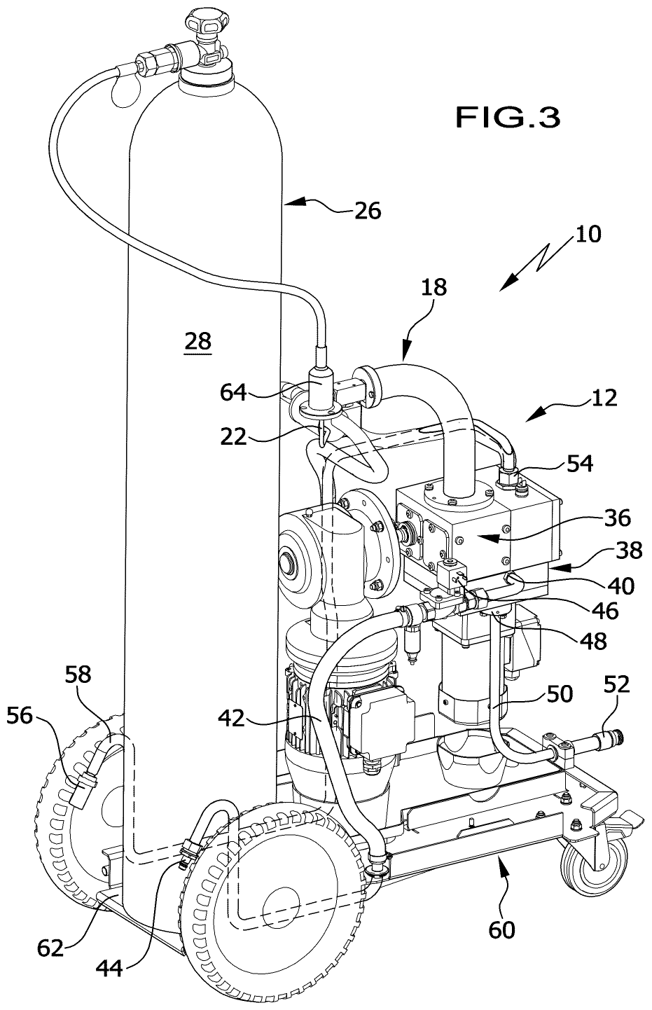

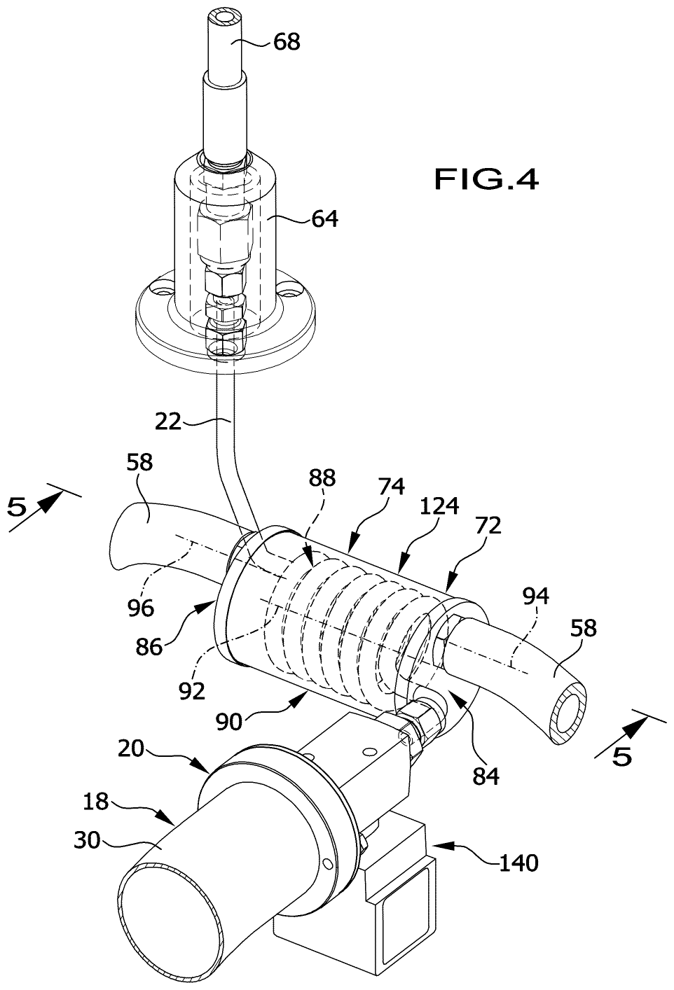

In the embodiment of the cleaning appliance 10 depicted in FIG. 7, the cooling device 24 is optionally configured in the form of an active cooling device 24, to which energy, for example electrical energy, must be supplied for cooling the CO₂ connection line 22, or in the form of a passive cooling device 24, which is explained in more detail below in connection with the embodiment depicted in FIGS. 1 to 6.

Schematically depicted in FIGS. 1 to 6 is a further embodiment of a cleaning appliance 10 for blasting surfaces to be treated with a mixed stream of a pressurized gas and CO₂ pellets. This embodiment of the cleaning appliance 10 also comprises an apparatus 12 for producing CO₂ pellets from liquid or gaseous CO₂.

The apparatus 12 comprises a compressing device 14 for compressing CO₂ snow to form the CO₂ pellets.

The compressing device 14 comprises an expansion device 16 for creating CO₂ snow by expanding liquid or pressurized CO₂. The expansion device 16 comprises an expansion chamber 18 in the form of a pipe 30 bent by 90°.

The expansion chamber 18 comprises an expansion chamber inlet 20, on which an expansion nozzle not depicted in the Figures is arranged, by means of which liquid or pressurized gaseous CO₂ is able to be conducted into the expansion chamber 18. The expansion chamber 18 forms a portion of a pre-compression device 32 in which CO₂ snow is pre-compressed and then supplied to the main compressing device 36 configured in the form of a gear compressor 34.

A pellet delivery device 38 is arranged downstream of the main compressing device 36.

The pellet delivery device 38 comprises a pressurized gas inlet 40, which is fluidically connected to a pressurized gas connection 44 by way of a connection line 42. Arranged on the connection line 42 is a valve 46 in order to selectively open or close the connection line 42 to enable or interrupt a pressurized gas stream.

The pellet delivery device 38 further comprises a mixed stream outlet 48, which is fluidically connected to a mixed stream connection 52 by way of a connection line 50. The mixed stream connection 52 can be connected by way of a hose to a blasting nozzle, which can be guided by a user for cleaning or blasting the surfaces to be treated with the mixed stream. For the sake of clarity, both the hose and the blasting nozzle are not depicted in the Figures.

The compressing device 14 comprises a CO₂ exhaust gas outlet 54, out of which gaseous CO₂ exits the compressing device 14, said gaseous CO₂ being created through sublimation during the production of CO₂ pellets.

The cleaning appliance 10 further comprises a CO₂ cleaning appliance exhaust gas outlet 56, which is fluidically connected to the CO₂ exhaust gas outlet 54, namely by way of a CO₂ exhaust gas line 58.

The cleaning appliance 10 further comprises a movable frame 60 on which all components of the cleaning appliance 10 are arranged. The cleaning appliance 10 can thus be moved by a user in a simple and comfortable manner.

Formed on the frame 60 is a platform 62 on which a CO₂ bottle 28 is positionable as schematically depicted in FIGS. 1 to 3. The CO₂ bottle 28 forms a CO₂ source 26.

The cleaning appliance 10 comprises a CO₂ connection 64, which is conducted out of a housing 66 of the cleaning appliance 10. The CO₂ connection 64 can be connected to a connection 70 of the CO₂ bottle 28 by way of a connecting line 68. The CO₂ connection 64 is fluidically connected to the CO₂ connection line 22 in this way.

In the embodiment of FIGS. 1 to 6, the cooling device 24 is configured in the form of a passive cooling device. It is configured in the form of a counterflow cooling device 72.

The cooling device 24 comprises a heat exchanger 74 through which the CO₂ connection line 22 extends.

The heat exchanger 74 defines or comprises a cooling channel 76 with a cooling channel inlet 78 and a cooling channel outlet 80. The CO₂ connection line 22, namely a connection line portion 82 of the CO₂ connection line 22, extends through the cooling channel 76.

The heat exchanger 74 defines an inlet side 84 and an outlet side 86, namely such that the cooling channel inlet 78 is arranged or formed on the inlet side 84 and that the cooling channel outlet 80 is arranged or formed on the outlet side 86.

The connection line portion 82 extends between the outlet side 86 and the inlet side 84 through the cooling channel 76.

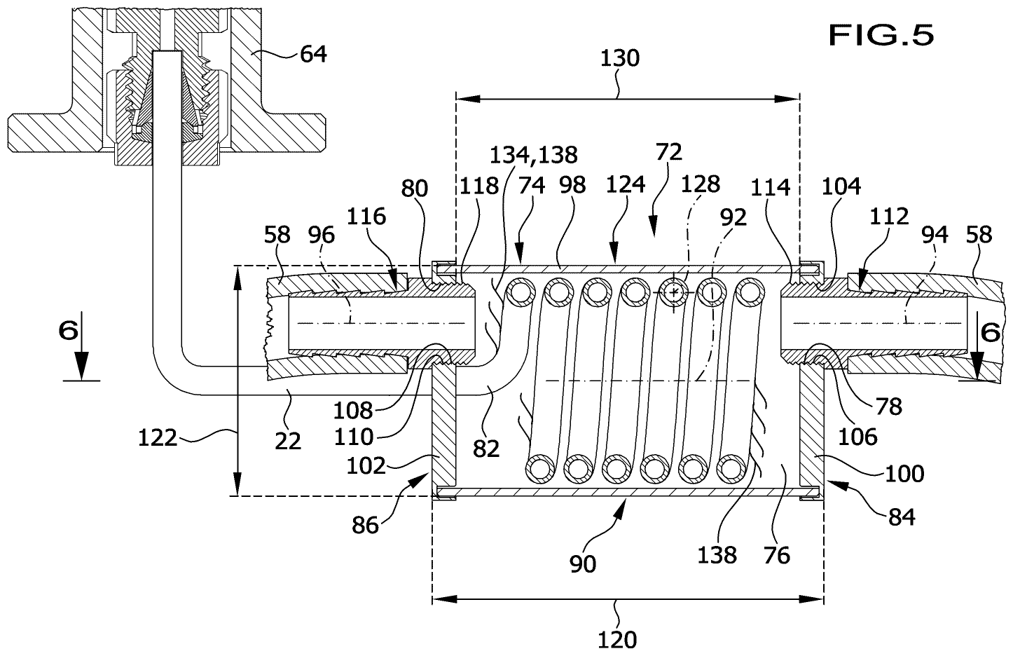

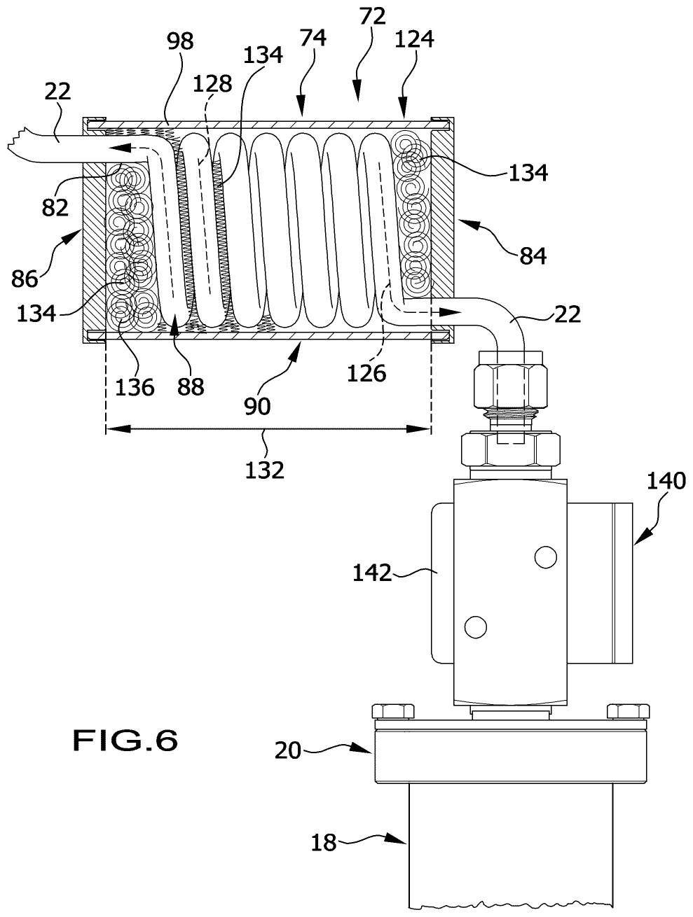

The connection line portion 82 is of helical configuration, as is schematically depicted, in particular, in FIGS. 5 and 6. It has the form of a helical coil 88.

The connection line portion 82 is of pipe-shaped configuration and is made of a metallic material.

The heat exchanger 74 comprises a heat exchanger housing 90, which delimits and thus defines the cooling channel 76. In the embodiment depicted in FIGS. 1 to 6, the heat exchanger housing 90 is of cylindrical or substantially cylindrical configuration and defines a heat exchanger housing longitudinal axis 92.

As schematically depicted in FIG. 5, both the cooling channel inlet 78 and the cooling channel outlet 80 are arranged or formed excentrically on the heat exchanger housing 90 relative to the heat exchanger housing longitudinal axis 92. This means, in particular, that both the cooling channel inlet 78 and the cooling channel outlet 80 are arranged or formed laterally offset on the inlet side 84 and on the outlet side 86, respectively, relative to the heat exchanger housing longitudinal axis 92.

The cooling channel inlet 78 defines a cooling channel inlet longitudinal axis 94. The cooling channel outlet 80 defines a cooling channel outlet longitudinal axis 96. In the embodiment depicted in the Figures, the cooling channel inlet longitudinal axis 94 and the cooling channel outlet longitudinal axis 96 extend in parallel to the heat exchanger housing longitudinal axis 92, but laterally offset therefrom. In other words, the heat exchanger housing longitudinal axis 92 does not coincide with the two other axes.

In the embodiment depicted in FIGS. 1 to 6, the cooling channel inlet longitudinal axis defines the cooling channel outlet longitudinal axis 96. The two axes are thus configured in alignment with one another.

The heat exchanger housing 90 comprises a pipe-shaped housing wall 98 extending concentrically to the heat exchanger housing longitudinal axis 92, as well as an end wall 100 defining the inlet side 84 and an end wall 102 defining the outlet side 86.

The cooling channel inlet 78 is configured in the form of a bore 106 of the end wall 100 provided with an internal thread 104. The cooling channel outlet 80 is configured in the form of a bore 110 of the end wall 102 provided with an internal thread 108.

The cooling channel inlet 78 comprises a hose connection piece 112, which comprises an externally threaded portion 114 corresponding to the internal thread 104. The hose connection piece 112 is screwed into the bore 106. An end portion of the hose connection piece 112 pointing away from the end wall 100 is connected to the hose-shaped CO₂ exhaust gas line 58, which is in direct fluidic connection with the CO₂ exhaust gas outlet.

A further hose connection piece 116 is screwed to the bore 110 with an externally threaded portion 118 corresponding to the internal thread 108. An end portion of the hose connection piece 116 pointing away from the end wall 102 is connected to a further portion of the CO₂ exhaust gas line 58 that is in direct fluidic connection with the CO₂ cleaning appliance exhaust gas outlet 56.

The heat exchanger housing 90 defines a heat exchanger housing length 120 and a heat exchanger housing diameter 122. In the embodiment depicted in FIGS. 1 to 6, a ratio between the heat exchanger housing length 120 and the heat exchanger housing diameter 122 is in a range of about 5:4 to about 5:1, namely somewhat more concretely in a range of about 3:2 to about 3:1. The heat exchanger housing 90 defines a heat exchanger housing wall 124 defining the cooling channel 76. The heat exchanger housing wall 124 is formed by the housing wall 98 and the two end walls 100 and 102.

The heat exchanger housing wall 124 is optionally thermally insulated. Optionally, it is made of a heat exchanger housing wall material, which has a thermal conductivity of at most about 1 W/(m K). In preferred embodiments, the thermal conductivity of the heat exchanger housing wall material is at most about 0.1 W/(m K).

In the embodiment depicted in the Figures, the connection line portion 82 has a connection line portion length 126. The connection line portion length 126 is defined by a length of the connection line portion 82 between the end walls 100 and 102, namely by a center line 128 of the connection line portion 82.

The cooling device 24 defines a cooling device length 130, which corresponds to a distance 132 between the inlet side 84 and the outlet side 86.

The helical configuration of the connection line portion 82 results in a ratio between the connection line portion length 126 and the cooling device length 130 in a range of about 5:1 to about 25:1. The surface area of the connection line portion 82 is increased in this way compared to a configuration in which the connection line portion would extend in parallel to the heat exchanger housing longitudinal axis 92 through the cooling channel 76.

For improving a heat exchange between the cooling channel 76 and the gaseous CO₂ flowing therethrough on the one hand and the connection line portion 82 and the liquid CO₂ flowing therethrough on the other hand, the cooling device 24 optionally comprises one or more heat conducting elements 134, which is/are in thermal connection with the connection line portion 82. As an example, a heat conducting element 134 in the form of a woven fabric body, knitted fabric body, or wool body 136 is depicted in FIG. 6.

Alternatively and purely schematically, optional heat conducting elements 134 in the form of heat conducting ribs 138 are drawn in FIG. 5 as an example. These also increase a surface area of the connection line portion 82 in the cooling channel 76 in order to achieve a heat exchange between the media flowing through the cooling channel 76 on the one hand and the connection line portion 82 on the other hand.

The heat conducting elements 134 are optionally made of a metallic material.

In one embodiment, the heat conducting elements 134 are made of a heat conducting body material, which has a thermal conductivity of at least about 30 W/(m K). Preferably, the thermal conductivity of the heat conducting body material is at least about 100 W/(m K).

In order to be able to control the inflow of liquid or pressurized CO₂ through the expansion chamber inlet 20, the expansion device 16 comprises a switching device 140 for opening and closing a fluidic connection between the CO₂ connection 64 and the expansion chamber inlet 20. The switching device 140 comprises an electromagnetic valve 142, which is arranged in the CO₂ connection line 22 in order to selectively open and close it. In the embodiment depicted in FIGS. 1 to 6, the switching device 140 is arranged or formed between the cooling device 24 and the expansion chamber inlet 20.

By means of the cooling device 24, an efficiency in the production of CO₂ pellets with the compressing device 14 can be significantly increased, namely by 25% compared to a cleaning appliance 10 that has no heat exchanger 74. In other words, this means that with the same contents of the CO₂ bottle 28, 25% more CO₂ pellets can be produced with the cleaning appliance 10 according to the embodiment of FIGS. 1 to 6, and thus a treatment duration increased by 25% for surfaces to be treated is achievable with equal CO₂ pellet quality and production rate. The CO₂ bottle 28 thus has to be replaced less frequently. Furthermore, costs in the operation of the cleaning appliance 10 can thus be significantly reduced and the environmental impact can be minimized.

### REFERENCE NUMERAL LIST

10 cleaning appliance
12 apparatus
14 compressing device
16 expansion device
18 expansion chamber
20 expansion chamber inlet
22 CO₂ connection line
24 cooling device
26 CO₂ source
28 CO₂ bottle
30 pipe
32 pre-compression device
34 gear compressor
36 main compressing device
38 pellet delivery device
40 pressurized gas inlet
42 connection line
44 pressurized gas connection
46 valve
48 mixed stream outlet
50 connection line
52 mixed stream connection
54 CO₂ exhaust gas outlet
56 CO₂ cleaning appliance exhaust gas outlet
58 CO₂ exhaust gas line
60 frame
62 platform
64 CO₂ connection
66 housing
68 connecting line
70 connection
72 counterflow cooling device
74 heat exchanger
76 cooling channel
78 cooling channel inlet
80 cooling channel outlet
82 connection line portion
84 inlet side
86 outlet side
88 helical coil
90 heat exchanger housing
92 heat exchanger housing longitudinal axis
94 cooling channel inlet longitudinal axis
96 cooling channel outlet longitudinal axis
98 housing wall
100 end wall
102 end wall
104 internal thread
106 bore
108 internal thread
110 bore
112 hose connection piece
114 externally threaded portion
116 hose connection piece
118 externally threaded portion
120 heat exchanger housing length
122 heat exchanger housing diameter
124 heat exchanger housing wall
126 connection line portion length
128 center line
130 cooling device length
132 distance
134 heat conducting element
136 wool body
138 heat conducting rib
140 switching device
142 valve

1. A cleaning appliance for blasting surfaces to be treated with a mixed stream of a pressurized gas and CO₂ pellets, comprising an apparatus for producing CO₂ pellets from liquid or gaseous CO₂, wherein the apparatus comprises a compressing device for compressing CO₂ snow to form the CO₂ pellets, wherein the compressing device comprises an expansion device for creating CO₂ snow by expanding liquid or pressurized CO₂, wherein the expansion device comprises an expansion chamber with an expansion chamber inlet, and wherein the cleaning appliance comprises a CO₂ connection line that is fluidically connected to the expansion chamber inlet for supplying the liquid or gaseous CO₂ to the expansion device, wherein the cleaning appliance comprises a cooling device for cooling the CO₂ connection line.

2. The cleaning appliance in accordance with claim 1, wherein the cooling device is configured in the form of a passive cooling device, in particular in the form of a counterflow cooling device.

3. The cleaning appliance in accordance with claim 1, wherein the cooling device comprises a heat exchanger and wherein the CO₂ connection line extends through the heat exchanger.

4. The cleaning appliance in accordance with claim 3, wherein the heat exchanger comprises a cooling channel with a cooling channel inlet and a cooling channel outlet and wherein the CO₂ connection line, in particular a connection line portion thereof, extends through the cooling channel.

5. The cleaning appliance in accordance with claim 4, wherein the heat exchanger has an inlet side and an outlet side and wherein the cooling channel inlet is arranged or formed on the inlet side and wherein the cooling channel outlet is arranged or formed on the outlet side.

6. The cleaning appliance in accordance with claim 5, wherein the connection line portion extends from the outlet side through the cooling channel to the inlet side or vice versa.

7. The cleaning appliance in accordance with claim 5, wherein the connection line portion has a connection line portion length, wherein the cooling device has a cooling device length, which corresponds to a distance between the inlet side and the outlet side, and wherein a ratio between the connection line portion length and the cooling device length is in a range of about 5:1 to about 25:1.

8. The cleaning appliance in accordance with claim 4, wherein at least one of the following applies:
a) the cooling channel inlet and/or the cooling channel outlet comprise a hose connection piece for connecting to a hose in a fluid-tight manner;
b) the compressing device comprises a CO₂ exhaust gas outlet and the CO₂ exhaust gas outlet is fluidically connected to the cooling channel inlet;
c) the cleaning appliance comprises a CO₂ cleaning appliance exhaust gas outlet and the cooling channel outlet is fluidically connected to the CO₂ cleaning appliance exhaust gas outlet.

9. The cleaning appliance in accordance with claim 4, wherein the cooling device comprises at least one heat conducting element, which is in thermal connection with the connection line portion.

10. The cleaning appliance in accordance with claim 9, wherein the at least one heat conducting element is configured in the form of a heat conducting rib projecting from the connecting line portion and/or in the form of a woven fabric body, knitted fabric body, or wool body.

11. The cleaning appliance in accordance with claim 9, wherein the at least one heat conducting element at least one of
a) is made of a heat conducting body material, which has a thermal conductivity of at least about 30 W/(m K), in particular at least about 100 W/(m K)
and
b) is made of a metallic material.

12. The cleaning appliance in accordance with claim 4, wherein the connection line portion at least one of
a) is of helical configuration, in particular in the form of a helical coil,
and
b) is made of a metallic material.

13. The cleaning appliance in accordance with claim 3, wherein the heat exchanger comprises a heat exchanger housing and wherein the heat exchanger housing defines the cooling channel.

14. The cleaning appliance in accordance with claim 13, wherein the heat exchanger housing defines a heat exchanger housing longitudinal axis and is of cylindrical or substantially cylindrical or cuboidal or substantially cuboidal configuration.

15. The cleaning appliance in accordance with claim 14, wherein the cooling channel inlet and/or the cooling channel outlet is/are arranged or formed excentrically on the heat exchanger housing relative to the heat exchanger housing longitudinal axis.

16. The cleaning appliance in accordance with claim 14, wherein the cooling channel inlet defines a cooling channel inlet longitudinal axis, wherein the cooling channel outlet defines a cooling channel outlet longitudinal axis, and wherein the cooling channel inlet longitudinal axis and/or the cooling channel outlet longitudinal axis extend in parallel to the heat exchanger housing longitudinal axis.

17. The cleaning appliance in accordance with claim 16, wherein the cooling channel inlet longitudinal axis defines the cooling channel outlet longitudinal axis.

18. The cleaning appliance in accordance with claim 17, wherein the heat exchanger housing at least one of
a) defines a heat exchanger housing length and a heat exchanger housing diameter and wherein a ratio between the heat exchanger housing length and the heat exchanger housing diameter is in a range of about 5:4 to about 5:1, in particular in a range of about 3:2 to about 3:1,
and
b) has a heat exchanger housing wall delimiting the cooling channel and wherein the heat exchanger housing wall is thermally insulated,
and
c) has a heat exchanger housing wall delimiting the cooling channel and wherein the heat exchanger housing wall is thermally insulated, wherein the heat exchanger housing wall is made of a heat exchanger housing wall material, which has a thermal conductivity of at most about 1 W/(m K), in particular at most about 0.1 W/(m K).

19. The cleaning appliance in accordance with claim 1, wherein the cleaning appliance comprises a CO₂ connection, which is connected or connectable to a CO₂ source, and wherein the CO₂ connection is fluidically connected to the CO₂ connection line.

20. The cleaning appliance in accordance with claim 19, wherein the expansion device comprises a switching device for opening and closing a fluidic connection between the CO₂ connection and the expansion chamber inlet and wherein the switching device is arranged or formed between the cooling device and the expansion chamber inlet.
